(19) United States
(12) Patent Application Publication
(10) Pub. No.: US 2018/0167283 A1
(43) Pub. Date: Jun. 14, 2018

(54) COMMUNICATION APPARATUS AND COMMUNICATION METHOD, COMMUNICATION SYSTEM, AND COMPUTER-READABLE STORAGE MEDIUM

(71) Applicant: CANON KABUSHIKI KAISHA, Tokyo (JP)

(72) Inventor: Kazuo Moritomo, Kawasaki-shi (JP)

(21) Appl. No.: 15/837,308

(22) Filed: Dec. 11, 2017

(30) Foreign Application Priority Data
Dec. 12, 2016 (JP) 2016-240566

(51) Int. Cl. H04L 12/24; H04W 12/04

(52) U.S. Cl. CPC H04L 41/12; H04W 84/12; H04W 12/04

(57) ABSTRACT

A communication apparatus: shares an encryption key of a public key encryption system with another communication apparatus through a first method; shares communication parameters for forming a communication network through a second method to execute a service with the other communication apparatus, the communication parameters being encrypted using the encryption key, with the other communication apparatus through a third method; provides a service to the other communication apparatus or receives a service from the other communication apparatus using the communication network of the second method formed with the other communication apparatus using the communication parameters; and selects the first method in accordance with a type of the service.

### BACKGROUND OF THE INVENTION

### Field of the Invention

The invention relates to a communication apparatus and a communication method, a communication system, and a computer-readable storage medium.

### Description of the Related Art

Electronic devices such as digital cameras, printers, cellular phones, smartphones, and the like are recently being given wireless communication functionality, and situations where such devices are connected to wireless LANs and used are on the rise. For devices to communicate over wireless LAN, various communication parameters must be set, such as encryption systems, encryption keys, authentication systems, and authentication keys.

Wi-Fi Protected Setup (WPS) is a technique that makes it easy to set such communication parameters. With WPS, the various parameters required for communication are concealed (encrypted) with a public key encryption system.

Japanese Patent Laid-Open No. 2014-524065 discloses a technique in which a key required by a public key encryption system is shared between devices through a QR code (trade name).

According to Japanese Patent Laid-Open No. 2014-524065, using a QR code makes it possible to securely share a key required by a public key encryption system between devices. However, using a QR code is not necessarily appropriate as a system for sharing a key required by a public key encryption system. For example, if a key is to be shared among a plurality of devices, each of those plurality of devices must capture an image of the QR code, which results in poor usability.

### SUMMARY OF THE INVENTION

Accordingly, one embodiment of the invention provides a technique that enables an encryption key to be shared between desired devices through an appropriate system, a communication network to be formed, and a service to be provided.

According to one aspect of the present invention, there is provided a communication apparatus comprising: a key sharing unit configured to share an encryption key of a public key encryption system with another communication apparatus through a first method; a parameter sharing unit configured to share communication parameters for forming a communication network through a second method to execute a service with the other communication apparatus, the communication parameters being encrypted using the encryption key, with the other communication apparatus through a third method; a control unit configured to provide a service to the other communication apparatus or receive a service from the other communication apparatus using the communication network of the second method formed with the other communication apparatus using the communication parameters; and a selecting unit configured to select the first method in accordance with a type of the service.

According to another aspect of the present invention, there is provided a communication system having a first communication apparatus and a second communication apparatus, the system comprising: a key sharing unit configured to share an encryption key of a public key encryption system between the first communication apparatus and the second communication apparatus through a first method; a parameter sharing unit configured to share communication parameters for forming a communication network through a second method to execute a service between the first communication apparatus and the second communication apparatus, the communication parameters being encrypted using the encryption key, between the first communication apparatus and the second communication apparatus through a third method; a control unit configured to provide a service from the first communication apparatus to the second communication apparatus or from the second communication apparatus to the first communication apparatus using the communication network of the second method formed between the first communication apparatus and the second communication apparatus using the communication parameters; and a selecting unit configured to select the first method in accordance with a type of the service.

According to another aspect of the present invention, there is provided a communication method for a communication apparatus, the method comprising: sharing an encryption key of a public key encryption system with another communication apparatus through a first method; sharing communication parameters for forming a communication network through a second method to execute a service with the other communication apparatus, the communication parameters being encrypted using the encryption key, with the other communication apparatus through a third method; providing a service to the other communication apparatus or receiving a service from the other communication apparatus using the communication network of the second method formed with the other communication apparatus using the communication parameters; and selecting the first method in accordance with a type of the service.

According to another aspect of the present invention, there is provided a computer-readable storage medium in which is stored a program for causing a computer to execute a communication method, the method comprising: sharing an encryption key of a public key encryption system with another communication apparatus through a first method; sharing communication parameters for forming a communication network through a second method to execute a service with the other communication apparatus, the communication parameters being encrypted using the encryption key, with the other communication apparatus through a third method; providing a service to the other communication apparatus or receiving a service from the other communication apparatus using the communication network of the second method formed with the other communication apparatus using the communication parameters; and selecting the first method in accordance with a type of the service.

Further features of the present invention will become apparent from the following description of exemplary embodiments (with reference to the attached drawings).

### BRIEF DESCRIPTION OF THE DRAWINGS

FIG. 1 is a block diagram illustrating an example of the hardware configuration of a digital camera.

FIG. 2 is a block diagram illustrating an example of the software configuration of the digital camera.

FIG. 3 is a diagram illustrating an example of a network configuration.

FIG. 4 is a flowchart illustrating a sequence of operations for determining a service providing device and a service utilizing device.

FIGS. 5A and 5B are flowcharts illustrating a sequence of operations performed by the service providing device.

FIG. 6 is a flowchart illustrating a sequence of operations performed by the service utilizing device.

FIG. 7 is an operation sequence chart.

FIG. 8 is a block diagram illustrating an example of the hardware configuration of a smartphone.

FIG. 9 is a block diagram illustrating an example of the software configuration of the smartphone.

FIG. 10 is an operation sequence chart.

FIG. 11 is an operation sequence chart.

FIG. 12 is a table illustrating provided services and public key sharing systems.

### DESCRIPTION OF THE EMBODIMENTS

Hereinafter, embodiments of the invention will be described in detail with reference to the appended drawings.

### First Embodiment

Hereinafter, a communication apparatus according to one embodiment (a first embodiment) of the invention will be described in detail with reference to the drawings. Although the following describes an example of a communication system that uses a wireless local area network (LAN) system based on the IEEE 802.11 series, the communication scheme is not limited to wireless LAN based on IEEE 802.11. Furthermore, it should be noted that the technical scope of the invention is defined by the appended claims, and is not intended to be limited by the individual embodiments described hereinafter.

Hardware Configuration

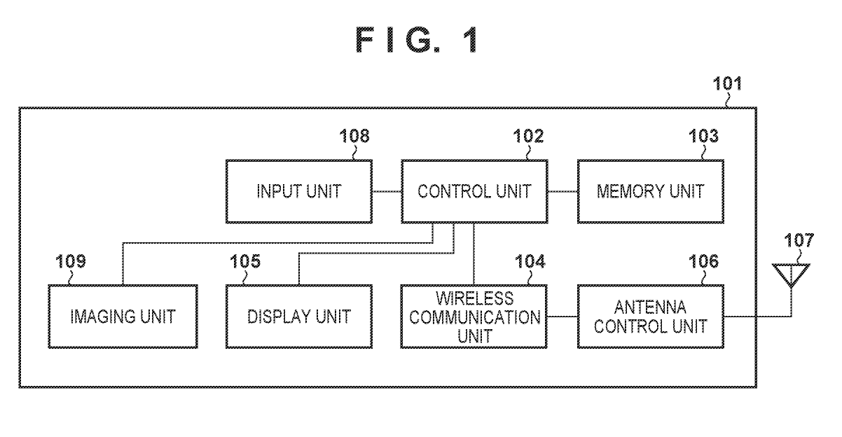

The hardware configuration of a digital camera serving as a communication apparatus according to this embodiment will be described first. FIG. 1 is a block diagram illustrating an example of the hardware configuration of the digital camera.

101 indicates the digital camera. 102 denotes a control unit (central processing unit; CPU) that controls the apparatus as a whole by executing a control program (computer program) stored in a memory unit 103. 103 denotes a memory unit that stores the control program executed by the control unit 102 as well as various information such as communication parameters. Various operations (described later) are carried out by the control unit 102 executing the control program stored in the memory unit 103. The memory unit 103 is realized by a storage device such as random access memory (RAM), read-only memory (ROM), a solid-state drive (SSD), or a magnetic hard disk.

104 denotes a wireless communication unit that processes wireless communication based on the IEEE 802.11 series, such as wireless LAN. The wireless communication unit 104 also controls the creation of wireless networks or communication parameters required to create networks. The wireless communication also includes short distance wireless communication such as near-field communication (NFC).

105 denotes a display unit that displays various items, and has functionality rendering it capable of outputting visually-recognizable information using a liquid-crystal display (LCD), light-emitting diodes (LED), or the like, and/or performing audio output using a speaker or the like. In other words, the display unit 105 includes functionality for outputting at least one of visual information and audio information. The display unit 105 also displays QR codes. Instead of QR codes being displayed through the display unit 105, a QR code may be affixed to the housing of the communication apparatus as a sticker or the like. The QR code may also be affixed to an instruction manual, packaging such as a cardboard box used when selling the communication apparatus, or the like.

107 denotes a wireless LAN antenna that transmits and receives radio waves. 106 denotes a wireless LAN antenna control unit that controls operations of the wireless LAN antenna 107. 108 denotes an input unit, through which a user makes various types of inputs, and that is used to operate the communication apparatus. 109 denotes an imaging unit that functions as a digital camera. The imaging unit 109 also has a function for capturing an image of a QR code or the like and processing the image.

Software Configuration

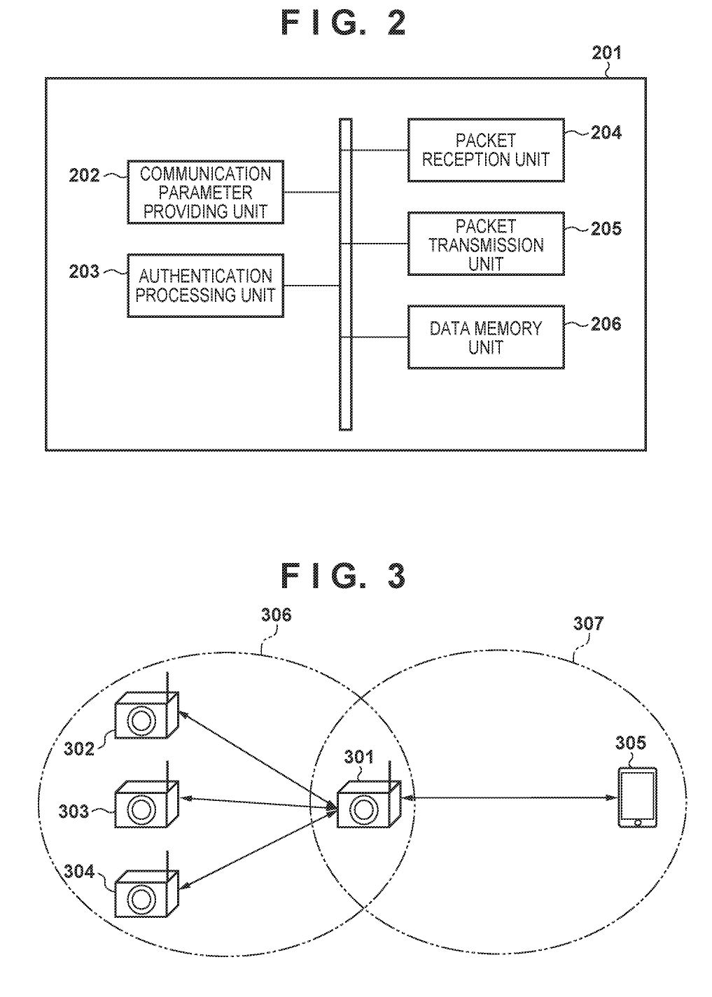

FIG. 2 is a block diagram illustrating an example of software function blocks of a digital camera that executes a communication control function (described later). 201 indicates all of the software function blocks of the digital camera.

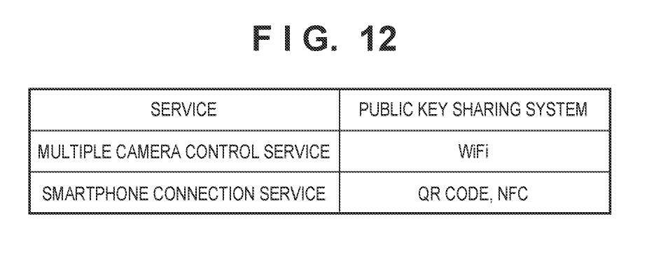

202 denotes a communication parameter providing unit. The communication parameter providing unit 202 serves as the provider of communication parameters of the communication apparatus itself, and generates and encrypts communication parameters, provides communication parameters to a partner apparatus, and so on. A parameter providing process (described later) is carried out by the communication parameter providing unit 202. 203 denotes an authentication processing unit that carries out an authentication process for the partner apparatus. Although details will be given later, it is necessary for the digital camera to communicate (notify) the various types of parameters required for the wireless LAN in a concealed (encrypted) state using a public key encryption system. Accordingly, the authentication processing unit 203 has a function for selecting or determining a system for sharing a public key on the basis of a service to be provided. This embodiment describes a plurality of services, namely a “multiple camera control service” and a “smartphone connection service”, as an example, but as will be described later, the system for sharing the public key is determined according to the table illustrated in FIG. 12.

204 denotes a wireless LAN packet reception unit (called a “packet reception unit 204” hereinafter) that receives wireless LAN packets from the partner apparatus. 205 denotes a wireless LAN packet transmission unit (called a “packet transmission unit 205” hereinafter) that transmits wireless LAN packets to the partner apparatus. In this manner, the digital camera carries out wireless LAN communication with the partner apparatus based on the IEEE 802.11 standard. 206 denotes a data memory unit that stores and holds software itself as well as wireless LAN parameters, authentication information, code information such as QR codes, and so on.

Note that all the function blocks have mutual relationships whether implemented as software or hardware. Accordingly, the above-described functions are realized by the control unit 102 controlling the operations of the apparatus as a whole on the basis of a computer program. Furthermore, the abovementioned function blocks are examples; a single function block may be made up of multiple function blocks, and any of the function blocks may be further divided into blocks that perform multiple functions.

System Configuration

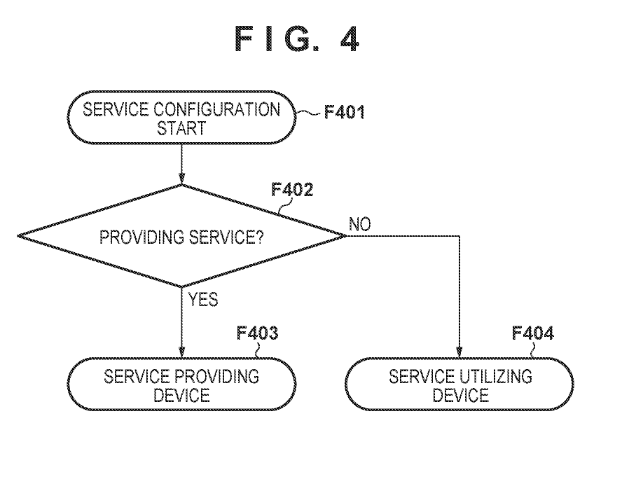

FIG. 3 is a diagram illustrating the configuration of a communication system including digital cameras 301 to 304, a smartphone 305, and wireless LAN networks 306 and 307 (called a “network 306” and a “network 307” hereinafter).

This embodiment describes an example of providing a service in which a plurality of digital cameras are operated from a specific digital camera to simultaneously shoot a subject (called a “multiple camera control service” hereinafter). The digital camera 301 constructs the network 306 in which such a service can be implemented. Furthermore, by allowing the digital cameras 302 to 304 to join the network 306 and use the service, the digital cameras 301 to 304 can shoot simultaneously from a plurality of angles. In this embodiment, the digital camera 301 has the configuration described earlier with reference to FIGS. 1 and 2. The network 306 and the network 307 are networks that communication devices having predetermined communication parameters can join, such as Wi-Fi Direct. Examples in which the smartphone 305 provides or is involved in using a service will be described later in second and third embodiments. Wi-Fi Direct is a system for forming a communication group in which a plurality of devices connect directly. In Wi-Fi Direct, it is determined whether each device will function as an access point or as a client when the communication group is formed. After these functions are determined, the access point provides and sets the various parameters required for communication to the clients.

Sequence of Operations

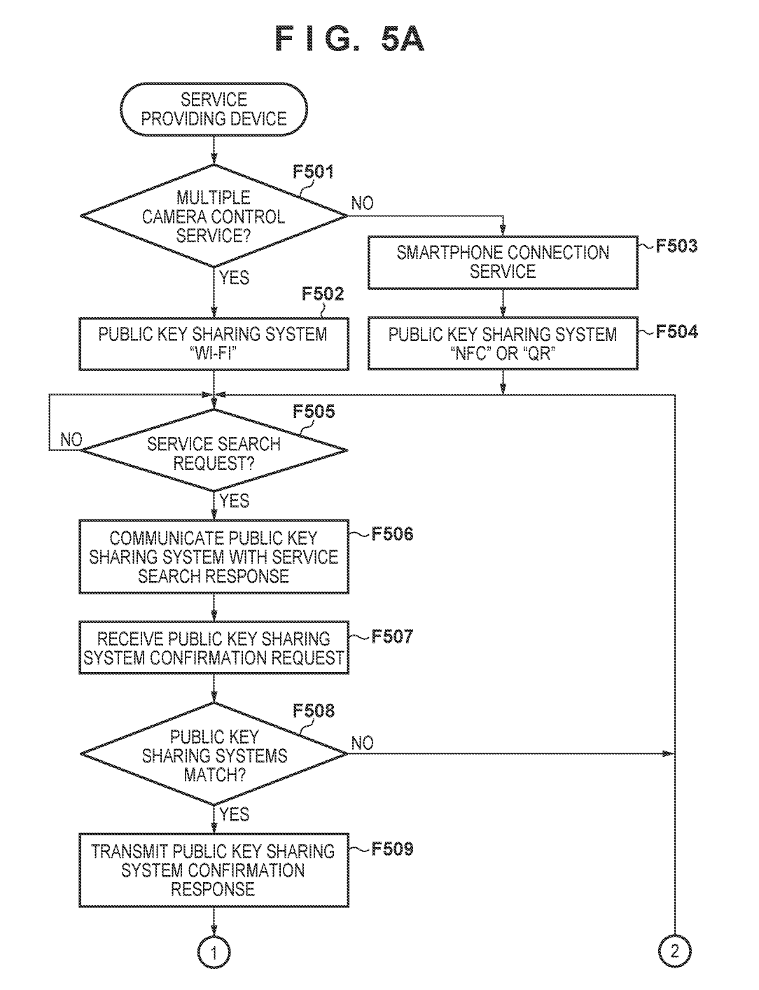

FIG. 4 is a flowchart illustrating a sequence of operations for determining whether a device is a device that provides the service implemented by the digital cameras 301 to 304 (called a “service providing device” hereinafter) or a device that utilizes the service (called a “service utilizing device” hereinafter).

A user of the digital camera 301 starts a service configuration process through the display unit 105 and the input unit 108 (F401), and selects either “service providing device” or “service utilizing device”. Here, the digital camera 301 serves as the device providing the service (YES in F402). In other words, an example in which the digital camera 301 is the service providing device and the digital cameras 302 to 304 are the service utilizing devices is described here.

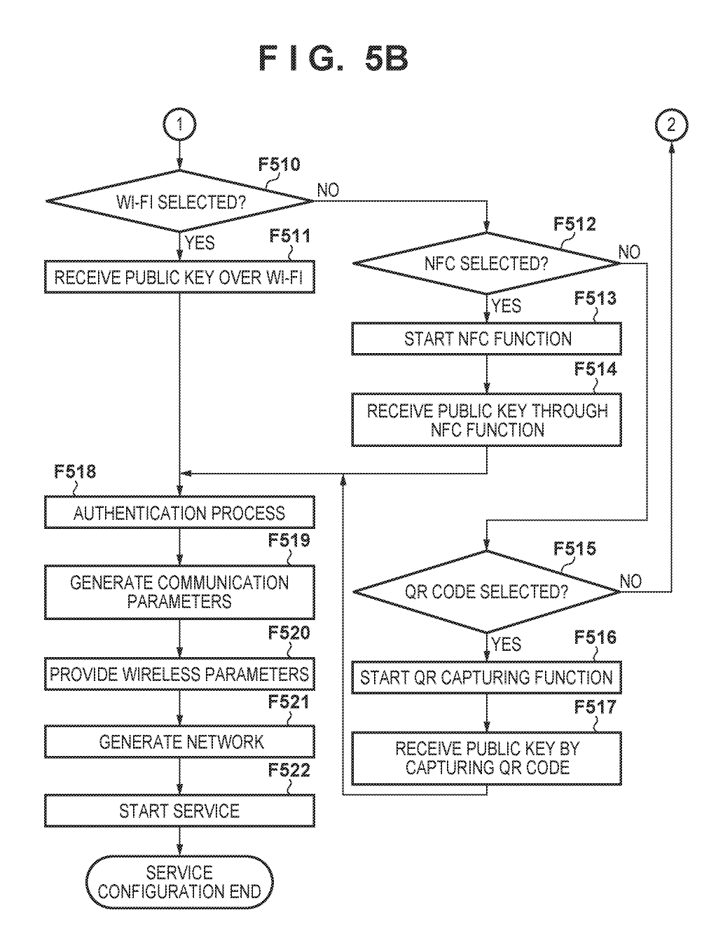

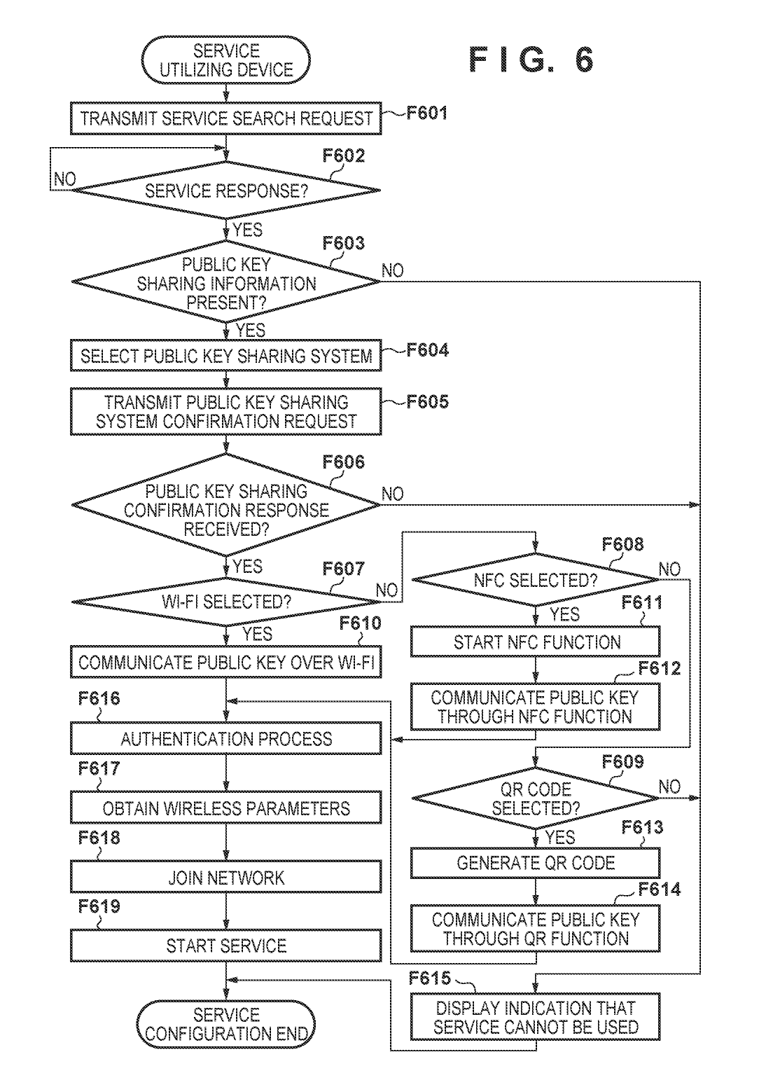

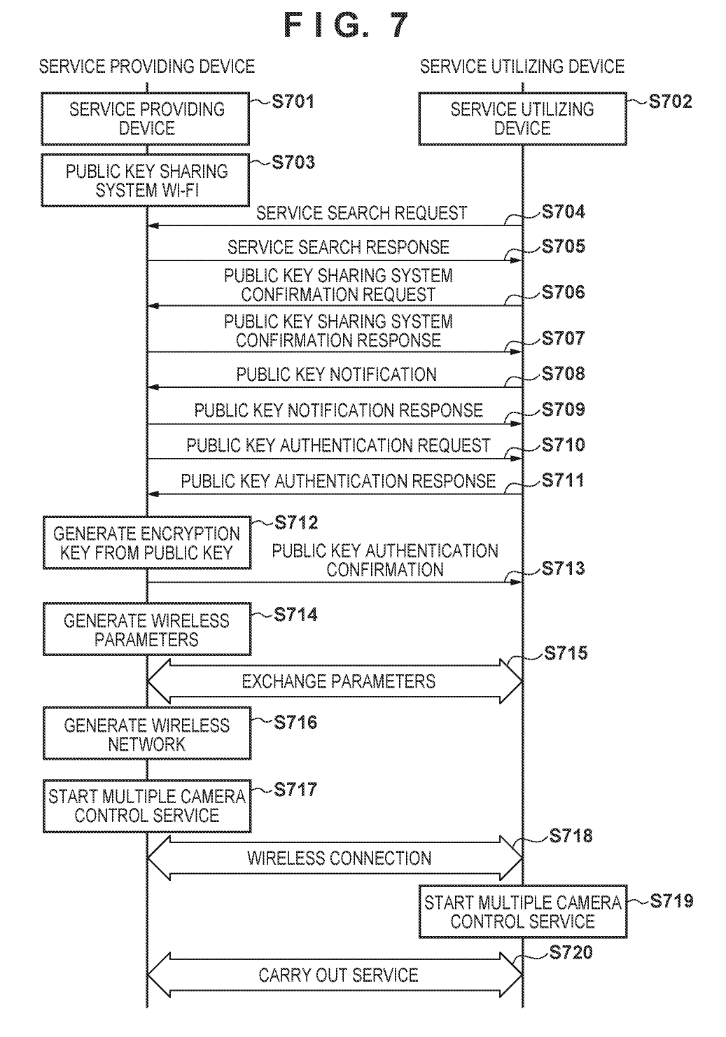

Descriptions will now be given using the flowchart for the service providing device (the digital camera 301) illustrated in FIGS. 5A and 5B, the flowchart for the service utilizing devices (the digital cameras 302 to 304) illustrated in FIG. 6, and the sequence chart illustrating operations according to this embodiment illustrated in FIG. 7. Because the digital cameras 302 to 304 carry out the same processing, only the processing carried out by the digital camera 302 will be described here, and the processing carried out by the digital cameras 303 and 304 will be omitted. Each step in the flowcharts and each sequence in the sequence chart is realized by the control unit 102 of the digital camera controlling operations of the apparatus on the basis of a computer program.

The digital camera 301 starts the multiple camera control service and sets itself as the service providing device (S701).

It is necessary for the digital camera 301 to construct the network 306 that enables that service and communicate the various necessary parameters to the service utilizing devices concealed using a public key encryption system. As such, it is necessary to use some system to share the public key used with the encryption system between the service providing device and the service utilizing devices. In this embodiment, the public key is shared smoothly among devices by determining the public key sharing system on the basis of the details of the service being provided. As such a configuration, this embodiment will describe an example in which the authentication processing unit 203 determines the public key sharing system according to the table illustrated in FIG. 12. In other words, when providing the multiple camera control service, the public key is shared over Wi-Fi, whereas when providing the smartphone connection service, the public key is shared using a QR code or NFC. When providing the smartphone connection service, the public key may be shared using Bluetooth Low Energy (BLE). In this embodiment, the multiple camera control service is used (YES in F501), and thus Wi-Fi is selected to be used (F502, S703).

Wi-Fi is selected in the table illustrated in FIG. 12 as the public key sharing system when using the multiple camera control service for the following reason. Using Wi-Fi makes it easy to share the public key with a plurality of devices (the digital cameras 302 to 304 in FIG. 3) functioning as service utilizing devices.

On the other hand, the smartphone connection service makes it possible to control the browsing, obtainment, and so on of images in a specific digital camera using a smartphone connected to the wireless LAN. Images in a digital camera may include items that are highly private or confidential. Accordingly, in this embodiment, the encryption key used to encrypt the communication parameters for providing such a service is shared using a communication method that requires the visual confirmation of the device used by the user, such as a QR code or NFC.

Thus in this embodiment, the communication method used in key sharing, where the encryption key according to the public key encryption system is shared with other communication apparatuses, is selected in accordance with the type of the service. This makes it possible to determine the appropriate communication method automatically in accordance with the details of the service, share the encryption key, form the communication network, and provide the service.

The public key sharing system may be determined automatically by a control program executed by the control unit 102, or may be determined by the user through the display unit 105 and the input unit 108. On the other hand, the digital camera 302 starts the multiple camera control service and sets itself as the service utilizing device (S702). Because the digital camera 302 is the service utilizing device, it is necessary to search out the device providing the multiple camera control service. To that end, the digital camera 302 transmits a service search request (F601, S704).

Upon receiving the service search request for searching for the multiple camera control service from the digital camera 302 (YES in F505), the digital camera 301 transmits a service search response indicating that the digital camera 301 itself is the device providing the service (F506). At this time, the digital camera 301 includes information pertaining to the public key sharing system selected in the process of F501, which here is Wi-Fi, in the service search response. In other words, the digital camera 301 transmits the service search response including information indicating that Wi-Fi is used as the public key sharing system when using the multiple camera control service (F506, S705). Wi-Fi Direct Service, which detects a service providing device over Wi-Fi, or a system using Bluetooth for detecting a service providing device, can be employed as the service search method. Additionally, when communicating the communication method corresponding to the type of the service in F506, it is possible to communicate at least one communication method.

Upon receiving the service search response (YES in F602), the digital camera 302 can confirm the presence of a device providing the multiple camera control service. As described above, in this embodiment, the service search response includes an indication that Wi-Fi is used as the public key sharing system used in the multiple camera control service (YES in F603). Accordingly, the authentication processing unit 203 of the digital camera 302 extracts “Wi-Fi” from the service search response as information pertaining to the public key sharing system (F604). The digital camera 302 transmits an indication that Wi-Fi will be used as the system for communicating the its own public key as a public key sharing system confirmation request (F605, S706).

Upon receiving the public key sharing system confirmation request (F507), the digital camera 301 confirms that the public key sharing system included in the request matches the system selected in the process of F501 (F508). If the system specified in the public key sharing system confirmation request does not match the system selected in the process of F501 (NO in F508), it is determined that the processing cannot continue, and the digital camera 301 stands by to receive a service search request (F505). Here, Wi-Fi is specified in the public key sharing system confirmation request, and this matches the public key sharing system selected in the process of F501 (YES in F508). Accordingly, an indication that there is no problem with the public key sharing system being Wi-Fi is transmitted to the digital camera 302 as a public key sharing system confirmation response (F509, S707).

Upon receiving the public key sharing system confirmation response (YES in F606), the digital camera 302 ascertains from that response that Wi-Fi has been confirmed as being used as the public key sharing system (YES in F607). The digital camera 302 then uses Wi-Fi to transmit its own public key to the digital camera 301 as a public key notification (F610, S708). Using the Action Frame defined in IEEE 802.11 can be considered as a specific method of carrying out this operation.

Upon receiving the public key notification (YES in F510, F511) and obtaining the public key of the digital camera 302, the digital camera 301 returns a public key notification response to the digital camera 302 (S709). After obtaining the public key of the digital camera 302, the digital camera 301 transmits a public key authentication request, including a hash value of the obtained public key information, to the digital camera 302 (S710).

After confirming the consistency of the hash value contained in the public key authentication request, the digital camera 302 transmits an authentication response indicating successful authentication to the digital camera 301 (S711). Upon receiving the authentication response indicating the successful authentication, the digital camera 301 computes the encryption key through the public key encryption system (S712) and transmits an authentication confirmation to the partner device (S713).

Through the authentication process, the digital camera 301 and the digital camera 302 both hold the public key used in the encryption process that follows thereafter (F518, F616). Using the Action Frame defined in IEEE 802.11, for example, can be considered as a specific method for the exchanges for generating the encryption key as well.

The digital camera 301 generates the various parameters necessary for the network 306 in order to construct the network 306 to be capable of implementing the multiple camera control service (F519, S714). The digital camera 301 furthermore conceals (encrypts) the generated parameters and communicates/provides those parameters to the digital camera 302 (F520, S715).

In this manner, the digital camera 301 carries out parameter sharing, in which the communication parameters for forming the communication network to provide a service to another communication apparatus, which have been encrypted using the encryption key, are shared with the other communication apparatus. Note that Wi-Fi, Bluetooth, or the like can be used as the communication method for sharing the communication parameters. The digital camera 301 constructs/forms the network 306 using the shared communication parameters (F521, S716), and starts providing the multiple camera control service (F522, S717). Here, the network 306 is formed through a communication method such as Wi-Fi Direct.

The digital camera 302 decrypts the received encrypted parameters necessary for the network 306 using the encryption key shared through the above-described method (F617). The digital camera 302 joins the network 306 on the basis of the decrypted parameters (F618, S718) and participates in the multiple camera control service (F619, S719).

The digital cameras 303 and 304 can also participate in the multiple camera control service by carrying out the same processing as the digital camera 302 and joining the network 306. The digital cameras 301 to 304 can therefore shoot simultaneously from a plurality of angles by using the multiple camera control service over the network 306 (S720).

As described above, when, in a system that provides a service using communication such as Wi-Fi Direct, communication parameters for that communication are encrypted through public key encryption and shared among communication terminals, the communication method for sharing the encryption key switches depending on the type of the service. Thus when providing a service in which it is less necessary to conceal information and ensure privacy, the communication network for providing the service can be formed easily using a wireless communication method such as Wi-Fi or Bluetooth. However, when providing a service that handles highly-private information, for example, the encryption key is shared using a communication method in which a user can visually confirm the apparatus to be communicated with, such as NFC or a QR code, which makes it possible to achieve the desired level of safety. Thus according to this embodiment, an encryption key can be shared between desired devices through an appropriate communication method, a communication network can be formed, and a service can be provided.

Although this embodiment describes an example in which the public key of a service utilizing device is provided to the service providing device by the service utilizing device as an example of sharing a public key through a public encryption system, the technique is not limited thereto. For example, the public key of a service providing device (the digital camera 301, for example) may be provided to a service utilizing device (the digital camera 302, for example) by the service providing device. In this case, the service utilizing device generates the communication parameters, encrypts the communication parameters using the public key (encryption key) of the service providing device, and transmits the encrypted parameters to the service providing device. Thus the encrypted communication parameters may be shared not by being provided to the service utilizing device by the service providing device, but rather by being provided to the service providing device by the service utilizing device.

An example of operations carried out when providing the smartphone connection service (F503, F504, and F512 to F517 in FIGS. 5A and 5B, and F608, F609, and F611 to F615 in FIG. 6) will be described later in the second and third embodiments. Finally, although Wi-Fi is used as the public key sharing system in this embodiment, the same effects can be achieved even when using another wireless method such as Bluetooth or Bluetooth Low Energy.

### Second Embodiment

The foregoing first embodiment describes an example in which the process of sharing a public key is implemented without going through a user by using Wi-Fi as the public key sharing system. However, with services requiring a high level of safety, there are cases where the user wishes to visually confirm the terminals to be used and determine whether or not the service can be used on a terminal-by-terminal basis. Thus a second embodiment of the invention will be described an example in which a user can confirm terminals allowed to join a service by using short distance wireless communication (NFC) to exchange public keys.

This embodiment describes a service in which the browsing, obtainment, and so on of images in a specific digital camera can be controlled using a smartphone connected to a wireless LAN (called a “smartphone connection service” hereinafter).

Hardware Configuration

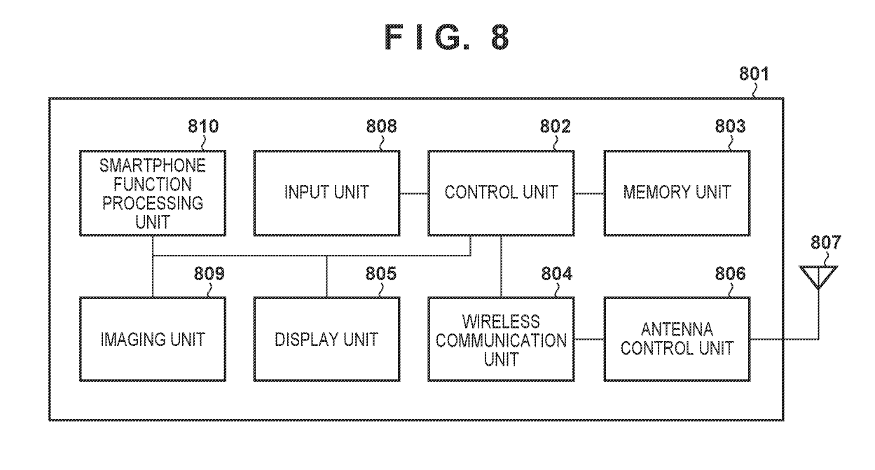

FIG. 8 is a block diagram illustrating an example of the configuration of a smartphone serving as a communication apparatus according to this embodiment. 801 indicates the overall apparatus.

802 denotes a control unit (CPU) that controls the apparatus as a whole by executing a control program (computer program) stored in a memory unit 803. The control unit 802 also controls the setting of communication parameters with other apparatuses. 803 denotes a memory unit that stores the control program executed by the control unit 802 as well as various information such as communication parameters. Various operations (described later) are carried out by the control unit 802 executing the control program stored in the memory unit 803. The memory unit 803 is realized by a storage device such as random access memory (RAM), read-only memory (ROM), a solid-state drive (SSD), or a magnetic hard disk.

804 denotes a wireless communication unit that carries out wireless communication based on the IEEE 802.11 series, such as wireless LAN. This wireless communication also includes short distance wireless communication such as NFC.

805 denotes a display unit that displays various items, and has functionality rendering it capable of outputting visually-recognizable information using an LCD, LEDs, or the like, or performing audio output using a speaker or the like. The display unit 805 includes functionality for outputting at least one of visual information and audio information. The display unit 805 also displays QR codes. Instead of QR codes being displayed through the display unit 805, a QR code may be affixed to the housing of the communication apparatus as a sticker or the like. The QR code may also be affixed to an instruction manual, packaging such as a cardboard box used when selling the communication apparatus, or the like.

807 denotes a wireless LAN antenna that transmits and receives radio waves. 806 denotes a wireless LAN antenna control unit that controls operations of the wireless LAN antenna 807. 806 denotes the wireless LAN antenna control unit, and 807 denotes the wireless LAN antenna. 808 denotes an input unit, through which a user makes various types of inputs, and that is used to operate the communication apparatus. 809 denotes an imaging unit that captures images of QR codes and the like.

Other functions typically included in a smartphone, such as a communication function and a web browsing function, are included in a smartphone function processing unit 810. Detailed descriptions of these functions will not be given here.

Software Configuration

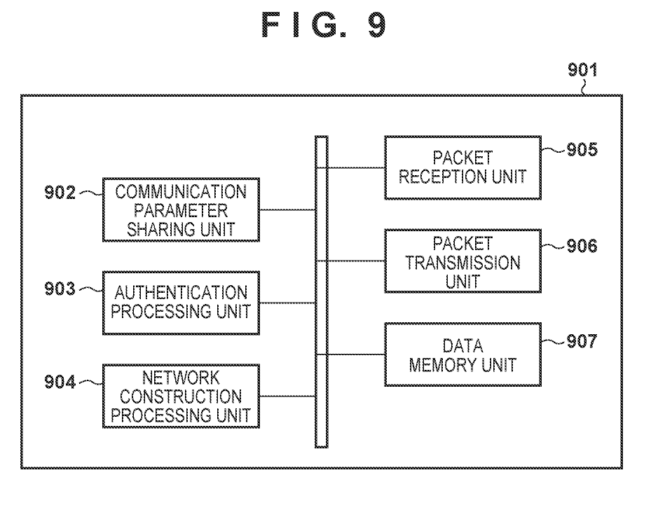

FIG. 9 is a block diagram illustrating an example of software function blocks of a smartphone that executes a communication control function (described later). 901 indicates all of the software function blocks of the smartphone.

902 denotes a communication parameter providing unit. The communication parameter providing unit 902 serves as the provider of communication parameters of the communication apparatus itself, and generates and encrypts communication parameters, provides communication parameters to a partner apparatus, and so on. A parameter providing process (described later) is carried out by the communication parameter providing unit 902. 903 denotes an authentication processing unit that carries out an authentication process for the partner apparatus. Although details will be given later, it is necessary for the digital camera to communicate the various types of parameters required for the wireless LAN in a concealed (encrypted) state using a public key encryption system. Accordingly, the authentication processing unit 903 has a function for selecting or determining a system for sharing a public key on the basis of a service to be provided. This embodiment describes a service called a “smartphone connection service” as an example, but like in the first embodiment, the system for sharing the public key is determined according to the table illustrated in FIG. 12.

904 denotes a network construction processing unit that constructs a network with other communication apparatuses, such as the digital camera 301, in order to provide/use a service.

905 denotes a wireless LAN packet reception unit (called a “packet reception unit 905” hereinafter) that receives wireless LAN packets from the partner apparatus. 906 denotes a wireless LAN packet transmission unit (called a “packet transmission unit 906” hereinafter) that transmits wireless LAN packets to the partner apparatus. In this manner, the smartphone carries out wireless LAN communication with the partner apparatus based on the IEEE 802.11 standard. 907 denotes a data memory unit that stores and holds software as well as wireless LAN parameters, authentication information, code information, and so on.

Note that all the function blocks have mutual relationships whether implemented as software or hardware. Accordingly, the above-described functions are realized by the control unit 802 controlling the operations of the apparatus as a whole on the basis of a computer program. Furthermore, the abovementioned function blocks are examples; a single function block may be made up of multiple function blocks, and any of the function blocks may be further divided into blocks that perform multiple functions.

Sequence of Operations

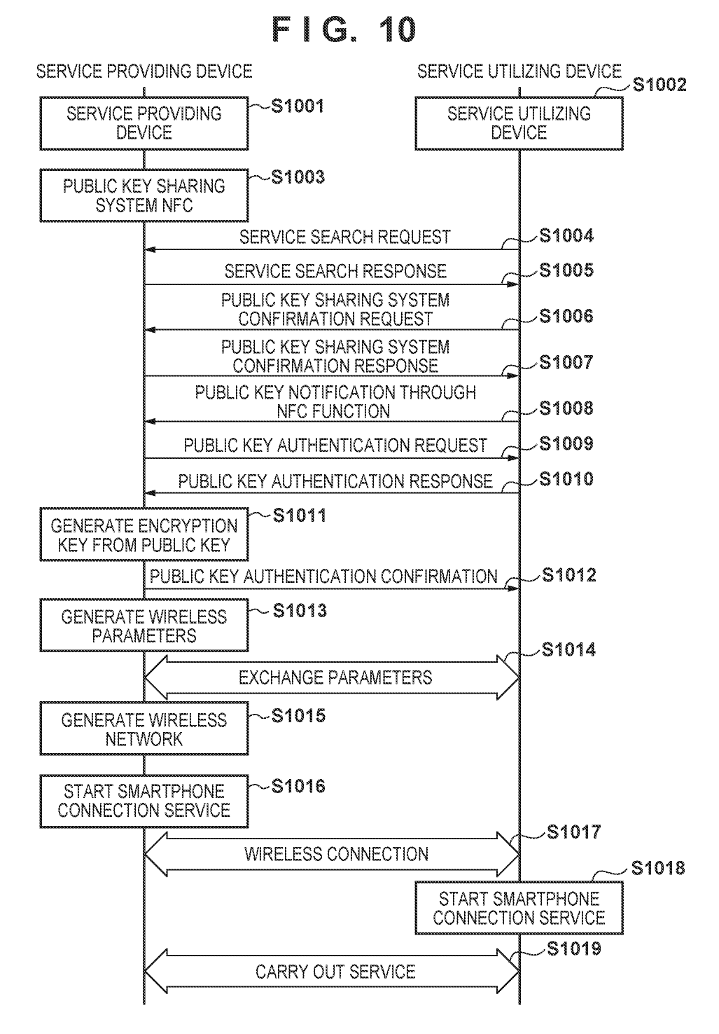

Operations according to this embodiment will be described next using the sequence chart illustrated in FIG. 10. In this embodiment, the smartphone functions as the service utilizing device, and thus the operations of the smartphone will be described using FIG. 6. The configurations of the digital cameras, the system configuration, and the flowchart for the digital camera 301 use the same diagrams as in the first embodiment (FIGS. 1 to 3, 5A and 5B).

The digital camera 301 starts the smartphone connection service and sets itself as the service providing device (S1001). It is necessary for the digital camera 301 to construct the network 307 that enables that service and communicate the various necessary parameters to the service utilizing devices concealed using a public key encryption system. As such, it is necessary to use some system to share the public key used with the encryption system between the service providing device and the service utilizing devices. Accordingly, in the digital camera 301 functioning as the service providing device, the authentication processing unit 903 determines the public key sharing system according to the table illustrated in FIG. 12. The smartphone connection service is used in this embodiment (NO in F501, F503), and thus the authentication processing unit 203 selects NFC or a QR code to be used (F504, S1003).

NFC or a QR code is selected in the table illustrated in FIG. 12 as the public key sharing system when using the smartphone connection service for the following reason. The data handled in this service is captured data within the digital camera 301, and is extremely private data. As such, it is necessary for the user of the digital camera 301 to specify the smartphone to connect to when using this service. Based on the above, NFC, which requires processing to be carried out near the digital camera 301, or a QR code, for which an image must be captured, is selected as the public key sharing system for the service. The selection of the public key sharing system may be determined automatically by a control program executed by the control unit 102, or may be determined by the user through the display unit 105 and the input unit 108.

On the other hand, the smartphone 305 starts the smartphone connection service and sets itself as the service utilizing device (S1002). Because the smartphone 305 is the service utilizing device, it is necessary to search out the device providing the smartphone connection service. To that end, the smartphone 305 transmits a service search request (F601, S1004).

Upon receiving the service search request for searching for the smartphone connection service (YES in F505), the digital camera 301 transmits a service search response including an indication that the digital camera 301 itself is the device providing the service. At this time, the digital camera 301 includes information pertaining to the public key sharing system selected in the process of F501 in the service search response. As described earlier, the digital camera 301 uses NFC or a QR code as the public key sharing system for using the service. Thus an indication thereof is included in the service search response (F506, S1005). Wi-Fi Direct Service, which detects a service provided over Wi-Fi or a device, or Bluetooth, can be considered as the service search method.

Upon receiving the service search response (YES in F602), the smartphone 305 can confirm the presence of a device providing the smartphone connection service. As described above, in this embodiment, the service search response includes an indication that NFC or a QR code is used as the public key sharing system used in the smartphone connection service (YES in F603). Accordingly, the authentication processing unit 903 extracts information pertaining to the public key sharing system from the service search response (F604). This embodiment describes an example in which the smartphone 305 selects NFC as the public key sharing system from the extracted public key sharing information. The smartphone 305 transmits an indication that NFC has been selected as a public key sharing system confirmation request (F605, S1006).

Upon receiving the public key sharing system confirmation request (F507), the digital camera 301 confirms that the public key sharing system included in the request matches the system selected in the process of F501 (F508). If the system specified in the public key sharing system confirmation request does not match the system selected in the process of F501 (NO in F508), the digital camera 301 determines that the processing cannot continue, and the digital camera 301 stands by to receive a service search request (F505). Here, NFC is specified in the public key sharing system confirmation request, and this matches the public key sharing system selected in the process of F501 (YES in F508). Accordingly, the digital camera 301 transmits an indication that there is no problem with the public key sharing system being NFC to the smartphone 305 as a public key sharing system confirmation response (F509, S1007).

Upon receiving the public key sharing system confirmation response (YES in F606), the smartphone 305 ascertains from that response that NFC has been confirmed as being used as the public key sharing system (NO in F607, YES in F608). The smartphone 305 starts an NFC function (F611), and communicates its own public key to the digital camera 301 using the NFC function (F612, S1008).

The digital camera 301 starts the NFC function (NO in F510, YES in F512, F513), and obtains the public key of the smartphone 305 through the NFC function (F514).

The same processing as that in the first embodiment is then carried out, resulting in a state where the digital camera 301 and the smartphone 305 both hold the shared key used in the encryption process (F518, F616, 51009 to S1012).

The digital camera 301 generates the various parameters necessary for the network 307 in order to construct the network 307 to be capable of implementing the smartphone connection service (F519, S1013). Furthermore, the parameters are encrypted and communicated to the smartphone 305 (F520, S1014). The digital camera 301 constructs the network 307 (F521, S1015) and starts the smartphone connection service (F522, S1016). Here, the network 307 is formed through a communication method such as Wi-Fi Direct.

The smartphone 305 decrypts the received encrypted parameters necessary for the network 307 using the encryption key shared through the above-described method (F617). The smartphone 305 joins the network 307 on the basis of the decrypted parameters (F618, S1017) and furthermore participates in the smartphone connection service (F619, S1018).

Thus by using the smartphone connection service over the network 307, the smartphone 305 can browse and obtain image data in the digital camera 301 (S1019).

As described thus far, in this embodiment, an encryption key for encrypting the communication parameters used to provide a service is shared through NFC in response to the smartphone connection service being selected. A user can therefore confirm the communication apparatus used when sharing the public key, which makes it possible to prevent a situation in which an apparatus unintended by the user participates in the service and private or sensitive information is leaked.

### Third Embodiment

In the second embodiment, the NFC function is employed as the public key sharing system. However, as described in the second embodiment, it is also conceivable to employ a QR code system as the public key sharing system. A third embodiment of the invention describes a case where a QR code system is applied in a smartphone connection service using the same configuration as that described in the second embodiment.

Sequence of Operations

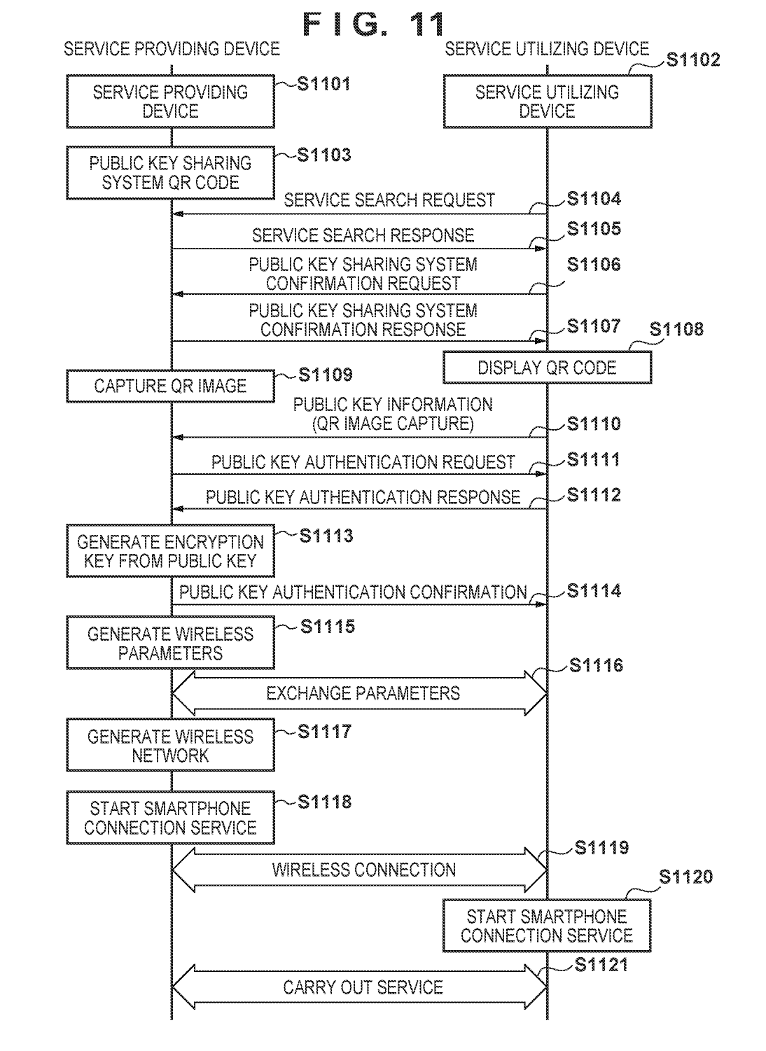

Operations according to this embodiment will be described next using the sequence chart illustrated in FIG. 11. Note that the diagrams referred to in the first and second embodiments will be used as the block diagram of the digital camera, the block diagram of the system, the flowchart for the digital camera 301, and the flowchart for the smartphone.

The processing until the smartphone 305 confirms the presence of a device providing the smartphone connection service is the same as the processing in the second embodiment, and thus will not be described here (F501 to F506, F601, 51101 to S1105). Upon receiving the service search response (YES in F602), the smartphone 305 can confirm the presence of a device providing the smartphone connection service.

As described above, in this embodiment, the service search response includes an indication that NFC or a QR code is used as the public key sharing system used in the smartphone connection service (F603). Accordingly, the authentication processing unit 903 extracts information pertaining to the public key sharing system from the service search response (F604). This embodiment describes an example in which the smartphone 305 selects “QR code” as the public key sharing system for using the smartphone connection service from the extracted public key sharing information. The smartphone 305 transmits an indication that “QR code” has been selected as a public key sharing system confirmation request (F605, S1106).

Upon receiving the public key sharing system confirmation request (F507), the digital camera 301 confirms that the public key sharing system included in the request matches the system selected in the process of F501 (F508). If the system specified in the public key sharing system confirmation request does not match the system selected in the process of F501 (NO in F508), the digital camera 301 determines that the processing cannot continue, and the digital camera 301 stands by to receive a service search request (F505). Here, “QR code” is specified in the public key sharing system confirmation request, and this matches the public key sharing system selected in the process of F501 (YES in F508). Accordingly, the digital camera 301 transmits an indication that there is no problem with the public key sharing system being “QR code” to the smartphone 305 as a public key sharing system confirmation response (F509, S1107).

Upon receiving the public key sharing system confirmation response (YES in F606), the smartphone 305 ascertains from that response that “QR code” has been confirmed as being used as the public key sharing system (NO in F607, NO in F608, YES in F609). The smartphone 305 generates a QR code including its own public key (F613) and displays that QR code in the display unit 805 (F614, S1108). Note that in the case where the selected public key sharing system is neither Wi-Fi, nor NFC, nor a QR code (NO in F607, NO in F608, and NO in F609), the smartphone 305 displays an indication that the service cannot be used in the display unit 805 (F615). In this manner, if at least one communication method communicated from another communication apparatus does not include a communication method with which the service utilizing device is compliant, the smartphone 305 carries out display control to display an indication thereof in the display unit 805. The “display” mentioned here may be a visual display in a display device, or a display made through audio output.

The digital camera 301 starts a QR code capturing function provided in the imaging unit 109 (NO in F510, NO in F512, YES in F515, F516). Then, the public key of the smartphone 305 is obtained by capturing an image of the QR code displayed in the display unit 805 of the smartphone 305 using the QR code capturing function (F517, 51109, S1110).

The same processing as that in the first and second embodiments is then carried out, resulting in a state where the digital camera 301 and the smartphone 305 both hold the shared key used in the encryption process (F518, F616, 51111 to S1114).

Furthermore, the digital camera 301 and the smartphone 305 start the smartphone connection service over the network 307 through the same processing as that described in the second embodiment. As a result of the digital camera 301 and the smartphone 305 using the service, image data in the digital camera 301 can be browsed and obtained (F519 to F522, F617 to F619, S1115 to S1121).

As described thus far, in this embodiment, an encryption key for encrypting the communication parameters used to provide a service is shared by capturing a QR code in response to the smartphone connection service being selected. As such, a user can confirm the communication apparatus used when sharing the public key. It is thus possible to prevent a situation in which an apparatus unintended by the user participates in the service and private or sensitive information is leaked.

The QR code is only one example of code information, and another two-dimensional code, a bar code, or the like may be used instead. Additionally, wireless LAN, Bluetooth, short distance wireless communication, and the display and capturing of code information are only examples of communication methods, and other communication methods may be used instead.

### Other Embodiments

Embodiments of the invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-240566, filed Dec. 12, 2016, which is hereby incorporated by reference herein in its entirety.

What is claimed is:

1. A communication apparatus comprising:
a key sharing unit configured to share an encryption key of a public key encryption system with another communication apparatus through a first method;
a parameter sharing unit configured to share communication parameters for forming a communication network through a second method to execute a service with the other communication apparatus, the communication parameters being encrypted using the encryption key, with the other communication apparatus through a third method;
a control unit configured to provide a service to the other communication apparatus or receive a service from the other communication apparatus using the communication network of the second method formed with the other communication apparatus using the communication parameters; and
a selecting unit configured to select the first method in accordance with a type of the service.

2. The apparatus according to claim 1, further comprising:
a forming unit configured to form the communication network with the other communication apparatus using the communication parameters.

3. The apparatus according to claim 1, further comprising:
a joining unit configured to join the communication network formed by the other communication apparatus using the communication parameters.

4. The apparatus according to claim 1, further comprising:
a notifying unit configured to notify the other communication apparatus of at least one communication method corresponding to the type of the service,
wherein the selecting unit selects the first method used by the key sharing unit in accordance with a response from the other communication apparatus made in response to the notification from the notifying unit.

5. The apparatus according to claim 4,
wherein in the case where there is no response from the other communication apparatus in response to the notification from the notifying unit, or in the case where a response including a designation of the first communication method not included in the at least one communication method has been returned from the other communication apparatus, the service is not provided.

6. The apparatus according to claim 1,
wherein the selecting unit selects wireless LAN, Bluetooth, communication based on short distance wireless communication, or displaying and capturing an image of code information as the first method in accordance with the type of the service.

7. The apparatus according to claim 1,
wherein the selecting unit selects, as the first method, a method included in at least one method corresponding to the type of the service notified from the other communication apparatus.

8. The apparatus according to claim 7, further comprising:
a display control unit configured to, in the case where a communication method that can be handled by the communication apparatus is not included in the at least one communication method notified from the other communication apparatus, display an indication thereof in a display unit.

9. The apparatus according to claim 1,
wherein the key sharing unit receives the encryption key of the other communication apparatus from the other communication apparatus through the first method.

10. The apparatus according to claim 9, further comprising:
a generating unit configured to generate the communication parameters; and
an encryption unit configured to encrypt the communication parameters using the encryption key received from the other communication apparatus,
wherein the parameter sharing unit transmits the encrypted communication parameters to the other communication apparatus.

11. The apparatus according to claim 1,
wherein the key sharing unit shares the encryption key of the communication apparatus with the other communication apparatus through the first method.

12. The apparatus according to claim 11,
wherein the parameter sharing unit receives the communication parameters encrypted using the encryption key from the other communication apparatus.

13. The apparatus according to claim 1,
wherein the second method is a communication method in which devices that can join the communication are restricted to devices holding the communication parameters.

14. The apparatus according to claim 1,
wherein the third method is wireless LAN or Bluetooth.

15. A communication system having a first communication apparatus and a second communication apparatus, the system comprising:
a key sharing unit configured to share an encryption key of a public key encryption system between the first communication apparatus and the second communication apparatus through a first method;
a parameter sharing unit configured to share communication parameters for forming a communication network through a second method to execute a service between the first communication apparatus and the second communication apparatus, the communication parameters being encrypted using the encryption key, between the first communication apparatus and the second communication apparatus through a third method;
a control unit configured to provide a service from the first communication apparatus to the second communication apparatus or from the second communication apparatus to the first communication apparatus using the communication network of the second method formed between the first communication apparatus and the second communication apparatus using the communication parameters; and
a selecting unit configured to select the first method in accordance with a type of the service.

16. A communication method for a communication apparatus, the method comprising:
sharing an encryption key of a public key encryption system with another communication apparatus through a first method;
sharing communication parameters for forming a communication network through a second method to execute a service with the other communication apparatus, the communication parameters being encrypted using the encryption key, with the other communication apparatus through a third method;
providing a service to the other communication apparatus or receiving a service from the other communication apparatus using the communication network of the second method formed with the other communication apparatus using the communication parameters; and
selecting the first method in accordance with a type of the service.

17. A computer-readable storage medium in which is stored a program for causing a computer to execute a communication method, the method comprising:
sharing an encryption key of a public key encryption system with another communication apparatus through a first method;
sharing communication parameters for forming a communication network through a second method to execute a service with the other communication apparatus, the communication parameters being encrypted using the encryption key, with the other communication apparatus through a third method;
providing a service to the other communication apparatus or receiving a service from the other communication apparatus using the communication network of the second method formed with the other communication apparatus using the communication parameters; and
selecting the first method in accordance with a type of the service.
